(19) United States
(12) Patent Application Publication
(10) Pub. No.: US 2014/0188496 A1
(43) Pub. Date: Jul. 3, 2014

(54) KNOWLEDGE AWARE CASE CART MANAGER SYSTEM

(71) Applicant: CERNER INNOVATION, INC., Lenexa, KS (US)

(72) Inventors: KAREN RAMSEY, Lenexa, KS (US); BRYAN MUEHLMEIER, Overland Park, KS (US); KRISTINE MARIE NESSA, Kansas City, MO (US)

(73) Assignee: CERNER INNOVATION, INC., Lenexa, KS (US)

(21) Appl. No.: 13/731,510

(22) Filed: Dec. 31, 2012

(51) Int. Cl. G06F 19/00; G06Q 50/22

(52) U.S. Cl. CPC G06F 19/327; G06Q 50/22
USPC 705/2

(57) ABSTRACT

Methods, computer systems, and computer storage media are provided for managing one or more case carts in a healthcare setting. Information associated with a case cart is received at a case cart manager system. Based on the information, at least one action is determined for the case cart, and the action is communicated to the case cart. The case cart or a user of the case cart is directed to perform the at least one action. Additionally, the case cart can detect its own status and generate status information that is communicated to and received at the case cart manager system.

### BACKGROUND

Healthcare facility case carts store tangible items including, most commonly, items used during surgery, such as surgical instruments, gauze, needles, bags, masks, gloves, medications, and containers. Some healthcare facility case carts house sterile items and are therefore sterilized between surgical cases. Other healthcare facility case carts do not house sterile items and may be used for managing and transporting other non-surgical items within a healthcare facility. Traditionally, healthcare facility employees have been responsible for locating, cleaning, filling, staging and moving case carts within a healthcare facility. Most often these efforts are coordinated with phone calls and paper communications.

A variety of healthcare systems, such as electronic medical record (EMR), real-time location, pharmacy, scheduling, inventory, purchasing and/or receivables, and case cart washer/sterilizer systems contain information relevant to the management of healthcare facility case carts. These healthcare systems do not typically communicate with each other and, when they do, they do not typically communicate information about the status or management of healthcare facility case carts. Facilitating communication about the status of healthcare facility case carts among these and other systems would save healthcare facilities time and money.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer storage media for managing case carts within a healthcare facility. Information associated with a case cart is received at a case cart manager system. Based on the information, at least one action is determined for the case cart, and the action is communicated to the case cart. The case cart or a user of the case cart is directed to perform the at least one action. Additionally, the case cart can detect its own status and generate status information that is communicated to and received at the case cart manager system.

Currently there is no centralized knowledge aware system that facilitates communication between a plurality of healthcare systems and healthcare facility case carts. A centralized knowledge aware case cart system likely would reduce the need for employee management of case carts. The knowledge aware case cart system could replace most paper communications and phone calls associated with the manual tracking of case carts. Likewise, eliminating manual tracking might decrease the wasted time, money and error associated with the non-automated management of case carts.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a system diagram of an exemplary system for managing at least one case cart in a healthcare facility suitable to implement embodiments of the present invention;

FIG. 3 depicts a flow diagram illustrating an exemplary method of communicating at least one action to at least one case cart according to an embodiment of the present invention; and

FIG. 4 depicts a flow diagram illustrating a method for directing a case cart or a user of the case cart to perform one or more actions associated with the case cart according to an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, computer systems, and computing storage media for managing one or more case carts in a healthcare facility. Information associated with a case cart is received at a case cart manager system. Based on the information, at least one action is determined for the case cart, and the action is communicated to the case cart. The case cart or a user of the case cart is directed to perform the at least one action. Additionally, the case cart can detect its own status and generate status information that is communicated to and received at the case cart manager system.

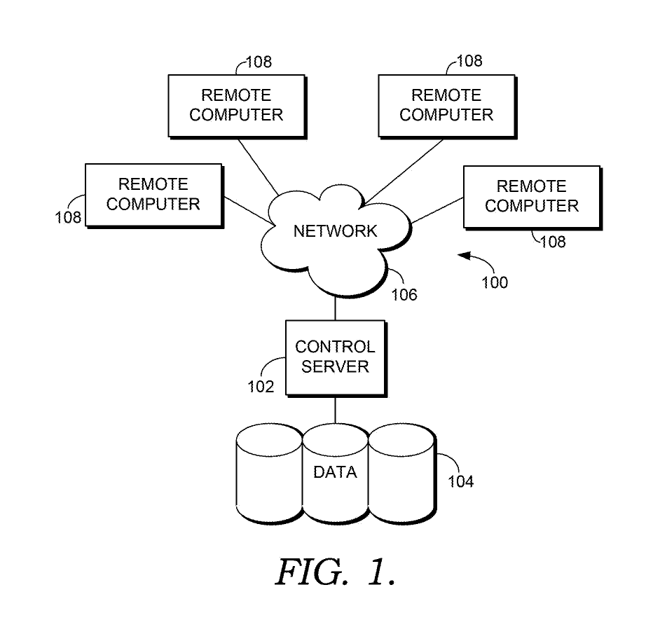

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

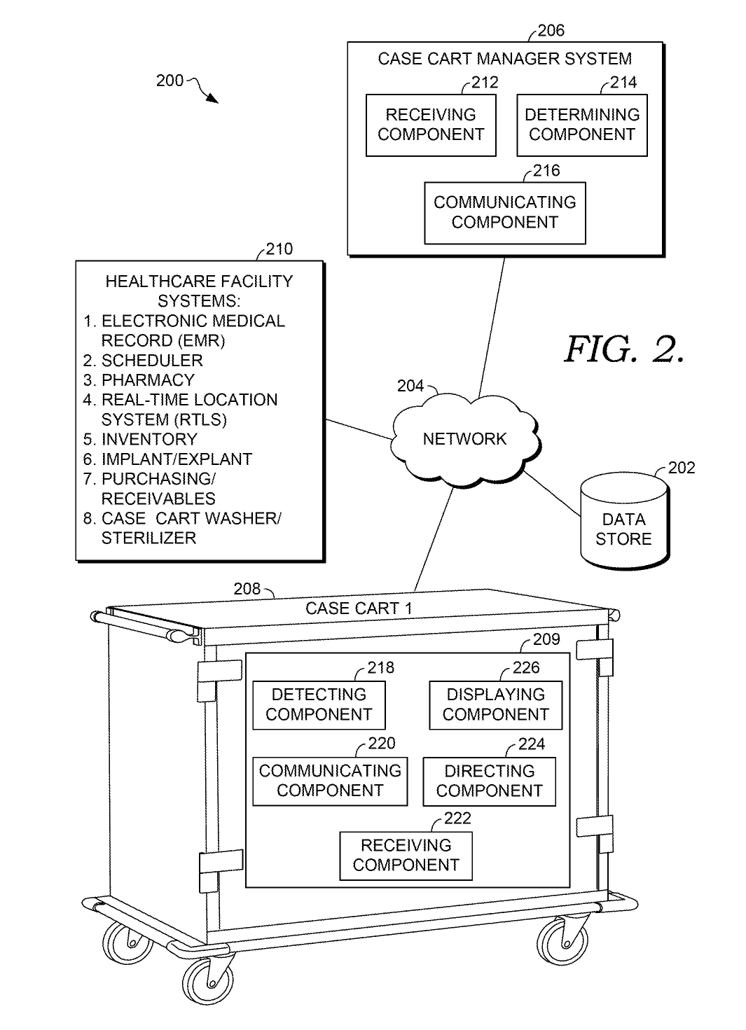

Turning now to FIG. 2, an exemplary computing system environment, referenced generally by the numeral 200, is depicted for managing one or more case carts within a healthcare facility. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a data store 202, a case cart manager system 206, a case cart 208 and an associated case cart system 209, and healthcare systems 210. The data store 202, the case cart manager system 206, the case cart system 209, and the healthcare systems 210 all communicate with one another via a network 204. The network 204 may include, without limitation, one or more local area networks (LANs) and/or wide area networks (WANs). Such networking environments are commonplace in offices, enterprise-wide computer networks, intranets and the Internet. Accordingly, the network 204 is not further described herein.

The data store 202, the case cart manager system 206, the case cart system 209, and the healthcare systems 210 are merely exemplary. While each of these components/services/modules is illustrated as a single unit, it will be appreciated that each of these components/services/modules is scalable. For example, the case cart manager system 206 and/or the case cart system 209 may in actuality include a plurality of computing devices in communication with one another. Components of the case cart manager system 206, the case cart system 209, and the healthcare systems 210 may include processing units, internal system memory, and suitable system buses for coupling various system components, including one or more data stores for storing information (e.g., files and metadata associated therewith). Each of these components/services/modules typically includes, or has access to, a variety of computer-readable media.

In some embodiments, one or more of the illustrated components/modules may be implemented as stand-alone applications. In other embodiments, one or more of the illustrated components/modules may be integrated directly into the case cart manager system 206 and/or the case cart system 209. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the case cart manager system 206 and/or the case cart system 209 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 202 is configured to store information for use by, for example, the case cart manager system 206, the case cart system 209, or the healthcare systems 210. The information stored in association with the data store 202 is configured to be searchable for one or more items of information stored in association therewith. The information stored in association with the data store 202 may comprise general information used by the case cart manager system 206, the case cart system 209 and/or the healthcare systems 210.

The data store 202 may store electronic medical records (EMRs) of patients associated with one or more healthcare facilities. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

The content and volume of such information in the data store 202 are not intended to limit the scope of embodiments of the present invention in any way. Further, though illustrated as a single, independent component, the data store 202 may, in fact, be a plurality of storage devices, for instance, a database cluster, portions of which may reside on the case cart manager system 206, the case cart system 209, the healthcare systems 210 and/or any combination thereof.

The healthcare systems 210 are configured to store information related to one or more healthcare facilities. The case cart manager system 206 can utilize the information stored by the healthcare systems 210 to determine one or more actions for the case cart 208. Exemplary systems within the healthcare systems 210 include electronic medical record (EMR), scheduler, pharmacy, real-time location, inventory, implant/explant, purchasing and receivables, and case cart washer and/or sterilizer systems. While the healthcare systems 210 are depicted as different systems in FIG. 2, these systems are shown merely as examples, and should not be construed as limiting. It will be understood that the healthcare systems 210 can include any system capable of communicating via the network 204. Likewise, it will be understood that each of the healthcare systems 210 may represent one or a plurality of systems. Further, the healthcare systems 210 may be located within a healthcare facility or located remotely.

The EMR system is associated with a healthcare facility such as a hospital or clinic, and is configured to process and store healthcare information in association with a data store such as the data store 202. In one embodiment, each item of healthcare information is associated with at least one patient.

The scheduler system is configured to schedule patients for healthcare events such as surgical procedures, administration of medical treatment or prescription medications, routine examinations and lab work. The scheduler system also tracks scheduling and staffing data for the healthcare facility. For instance, the scheduler system can schedule a clinician for surgery. Similarly, the scheduler system may schedule devices, equipment, inventory, case carts, or the like for a healthcare event. Finally, the scheduler system can schedule or reserve rooms, such as operating, imaging, examination, or conference rooms for use within a healthcare facility.

The pharmacy system stores patient information related to prescription or over-the-counter medications and/or products including a particular patient's prescription dose levels, usage instructions, side effect information, and pick-up and/or delivery information. The pharmacy information may also include patient healthcare information such as a patient's allergies to medications and/or prescription drugs. The pharmacy system also is configured to store information associated with, for instance, a patient's medication history and prescribing doctors.

The real time location system (RTLS) may utilize any technology known in the art to track identifiers such as ultrasound technology, infrared (IR) technology, radio-frequency identification technology (RFID), or wireless local area networks. The RTLS is configured to utilize, for example, RFID identifiers to track, locate and identify not only clinicians, but also patients and other individuals wearing an identifier. The RTLS can also track and locate equipment, devices, and inventory, etc. Exemplary identifiers may include badges, tags, and wristbands. For example, the RTLS can locate the case cart 208 and inventory items stored on the case cart 208 that are equipped with an identifier.

The inventory system is configured to keep track of and store information about inventory that is currently available in a healthcare facility. Within the inventory system, orders for new inventory may be placed. The inventory system also can store information about where inventory is located within a healthcare facility and which healthcare facility employees have access to the inventory. Inventory can include any number of items, including items stored on a case cart, such as gauze, needles, scalpels, surgical instruments, sutures, gloves, cover gowns, masks, or other disposable or reusable materials.

The implant system is a system that receives and stores information about tissues and/or organs that are available or targeted for implantation into one or more patients. In one embodiment, the implant system communicates with the EMR and the purchasing and/or receivables system to provide comprehensive information related to a transplant surgery. In this way, the EMR system may be aware that a patient is scheduled for and needing a transplant surgery, the implant system may be aware of the type, location, and origination of the organ or tissue that is to be transplanted, and the purchasing and/or receivables system may be aware of the arrival of the implant at the healthcare facility. Likewise, the explant system stores information about organs and/or tissues that have been surgically extracted from a patient. In some embodiments the explant system may be integrated into, the same as, or coupled with the implant system.

The purchasing and/or receivables system tracks purchases made and items received at a healthcare facility. The purchasing and/or receivables system can also determine information such as which employee(s) purchased or received shipment of inventory, which employee(s) authorized payment, what type of payment was used, and when and where an item was delivered. Some receivables information may not be associated with purchasing information (e.g., information about a newly-received transplant organ), and thus may be stored separately from the purchasing information.

The case cart washer system is configured to wash and/or sterilize case carts in a healthcare facility. A case cart washer may be automated (i.e., not requiring user intervention) and able to communicate with an automated case cart (e.g., a case cart equipped with a robotics system). The case cart washer may be an open or enclosed system and can hold at least one case cart.

As shown in FIG. 2, the case cart manager system 206 comprises a receiving component 212, a determining component 214, and a communicating component 216. The case cart manager system 206 typically includes, or has access to, a variety of computer-readable material. In some embodiments, one or more of the components 212, 214, and 216 may be implemented as stand-alone applications. In other embodiments, one or more of the components 212, 214, and 216 may be integrated directly into the operating system of a computing device such as the remote computer 108 of FIG. 1. It will be understood that the components 212, 214, and 216 illustrated in FIG. 2 are exemplary in nature and in number and should not be construed as limiting. Any number of components may be employed to achieve the desired functionality within the scope of embodiments hereof.

The receiving component 212 of the case cart manager system 206 is configured to receive information associated with a healthcare facility from, for example, the data store 202, the case cart system 209, and the healthcare systems 210. Further, information received by the receiving component 212 can be associated with one healthcare facility or multiple healthcare facilities.

Exemplary information received by the receiving component 212 may include, for instance, general information about the case cart 208 or the status of the case cart 208. General information about the case cart 208 is received from the healthcare systems 210 or the data store 202. Status information is received from the case cart 208. Status information includes, for instance, information about the remaining battery life of the case cart 208, the inventory stored on the case cart 208, or whether the case cart 208 is clean or dirty. General information might include a list of available inventory in a healthcare facility, patient clinical documentation from the EMR system, a list of available rooms within a healthcare facility, scheduling information, the location of a patient, clinician, device, equipment, or the case cart 208 within a healthcare facility, a list of available medications, a list of medications that need to be sent to a patient, a notification that a transplant arrived at a docking station and needs to be delivered to a patient, a notification that new supplies or inventory have arrived at a healthcare facility, and a notification that a case cart washer/sterilizer is in use or, alternatively, is available.

The receiving component 212 is configured to receive dynamically updated information. Dynamically updated information is information that is updated in real or near real-time. For example, if the scheduler system receives information that the case cart 208 is no longer scheduled for surgery in operating room (OR) 1, but instead is scheduled for surgery in OR 2, the information is sent to the receiving component 212 as soon as it is updated in the scheduler system.

The determining component 214 is configured to dynamically determine at least one action for the case cart 208 and/or a user of the case cart 208 based on information received at the receiving component 212. Exemplary actions for the case cart 208 include, for example, moving from a first location to a second location, being refilled with inventory, unloading inventory, being staged with inventory, being cleaned or sterilized, being recharged, maintaining current operations, or parking.

The determining component 214 can also prioritize actions for the case cart 208. For instance, if the case cart 208 needs to be restocked before being sent to an operating room for surgery, the determining component 214 is configured to determine that one action (e.g., restocking the case cart 208) must be completed before another action (e.g., moving the case cart 208 to an operating room) can be successfully performed.

The determining component 214 also is configured to determine whether one or more actions for the case cart 208 have been performed. The determining component 214 utilizes updated information received at the receiving component 212 to make the determination. For example, the determining component 214 may determine that an action to “move” the case cart 208 from OR 1 to examination room B is needed. The receiving component 212 later may receive information from the RTLS that the case cart 208 is located in examination room B. The determining component 214 may determine, therefore, that the case cart 208 was moved from OR 1 to examination room B, and thus the action was performed. Likewise, the determining component 214 can compare at least two items of received information to determine if an action was performed. For instance, the determining component 214 may compare earlier-received status information that the case cart 208 was “empty” with more recently-received status information that the case cart 208 is “full” to determine that the action of “refilling” the case cart 208 was performed.

The communicating component 216 is configured to communicate at least one action to the case cart 208. The communicating component is also configured to communicate the action to a plurality of other systems including, for example, the healthcare systems 210 or the data store 202. In one aspect, the communicating component 216 dynamically (i.e., in real time or near real-time) communicates the one or more actions. The communicating component 216 can also communicate the action to a user of a remote computer, such as the remote computer 108 of FIG. 1. For example, the communicating component 216 may be configured to communicate at least one action for the case cart 208 to a healthcare facility employee workstation. At the workstation, the employee may receive a communication that the case cart 208 needs to be moved from OR 1 to emergency room (ER) 8, prompting the employee to move the case cart 208 from OR 1 to ER 5.

Continuing with respect to FIG. 2, the case cart system 209 comprises a detecting component 218, a communicating component 220, a receiving component 222, a directing component 224, and a displaying component 226. The case cart system 209 typically includes, or has access to, a variety of computer-readable material. In some embodiments, one or more of the components 218, 220, 222, 224, and 226 may be implemented as stand-alone applications. In other embodiments, one or more of the components 218, 220, 222, 224, and 226 may be integrated directly into the operating system of a computing device such as the remote computer 108 of FIG. 1. It will be understood that the components 218, 220, 222, 224, and 226 illustrated in FIG. 2 are exemplary in nature and in number and should not be construed as limiting. Any number of components may be employed to achieve the desired functionality within the scope of embodiments hereof.

The case cart system 209 is depicted, for simplicity sake, as a single unit. The case cart system 209, however, is merely exemplary. It will be understood that the case cart system 209 may represent more than one case cart system configured to communicate via the network 204. By way of example, a healthcare facility may have sixty different case carts that communicate via the network 204. The case cart system 209 is meant to represent, for instance, any one or all sixty of the case carts systems communicating via the network 204.

The detecting component 218 is configured to dynamically detect at least a first status of the case cart 208 and generate status information based on the status of the case cart 208. The status information may include, for example, information indicating that a case cart is low on battery charge, filled or unfilled (e.g., with inventory), clean or dirty, assigned, available, ready, broken or fixed, returned, parked, needing maintenance, washed, en route to a location, or any combination thereof.

In one embodiment, the detecting component 218 is configured to scan the inventory stored on or in the case cart 208 and generate information comprising an indication of the inventory associated with the case cart 208. The inventory associated with the case cart 208 may include at least an indication of inventory stored on or in the case cart 208.

In another embodiment, the detecting component 218 is configured to monitor the battery charge remaining in the case cart 208 and generate information comprising at least an indication of the amount of battery charge remaining in the case cart 208. The information generated may also include an indication of whether the battery needs recharging or replacement.

The communicating component 220 is configured to dynamically (i.e., in real or near real-time) communicate information to the case cart manager system 206. The communicating component 220 is also configured to communicate information to a plurality of other systems including, for example, the healthcare systems 210, the data store 202, or a robotics system (not shown) located on the case cart 208. The communicating component 220 may also be configured to communicate with automated devices within a healthcare facility to facilitate performing at least one action for the case cart 208. For example, the communicating component 220 can communicate to an automated door that it should open so the case cart 208 can pass through the door space. Similarly, the communicating component 220 may communicate to an elevator that the automated elevator door should open and the elevator should move to a different floor within a healthcare facility. The communicating component 220 is configured to dynamically communicate the one or more actions.

The receiving component 222 is configured to receive one or more communications from the case cart manager system 206, at least one communication comprising an indication of at least one action for the case cart 208. An action may include changing locations, getting washed and/or sterilized, picking up inventory, picking up an organ for a transplant operation, parking, recharging, and the like.

The directing component 224 directs the case cart 208 and/or a user of the case cart 208 to perform the one or more actions based on a communication of the actions to the receiving component 222. A user of the case cart 208 may include a clinician, a healthcare facility employee, or any other person responsible for managing the case cart 208. In one embodiment, the directing component 224 directs a user of the case cart 208 to perform the one or more actions by communicating a notification to the displaying component 226, described below. In another embodiment, the directing component 224 directs an automated version of the case cart 208 to perform the one or more actions automatically (i.e., without user intervention). The automated version of the case cart 208 is equipped with a robotics system separately installed within or on the case cart 208. In particular, the directing component 224 is configured to direct a robotics systems located on the case cart 208 to perform some action with respect to the case cart 208. For example, the directing component 220 communicates to the robotics system that the robotics system should move the case cart 208 from one room to another without user assistance, and the robotics system will thereafter move the case cart 208.

In one embodiment, an action may be performed or facilitated solely by one or more users of the case cart 208. For example, a user of the case cart 208 may manually push the case cart based on a communicated action that the case cart “move”. In other embodiments, the action may be performed when the directing component 224 directs a robotics system on the case cart 208 to execute the action. For instance, an automated version of the case cart 208 might automatically (i.e., without user intervention) move itself around a healthcare facility based on the same communicated action that the case cart 208 “move”. In still other embodiments, the action may be performed by a combination of the automated version of the case cart 208 and one or more users of the case cart 208. For instance, the automated version of the case cart 208 may automatically move to a recharging station based on receiving a communication that the case cart 208 needs “recharging”. A user of the case cart 208 may then plug the case cart 208 into the recharging station to complete the action.

As shown, the case cart system 209 may also include a displaying component 226. The displaying component 226 is configured to present information to the user of the case cart 208, such as a notification requesting the user to perform at least one action with respect to the case cart 208. The displaying component 226 may display the notification on any number or variety of display screens. The notification is not meant to be limited to merely visual displays. The notification can include sounds, lights, written instructions/commands, and the like. For instance, if the case cart 208 needs recharging, a red flashing low battery light may appear on the exterior of the case cart 208.

In one embodiment, the displaying component 226 may be configured to generate a textual message that is displayed on a user interface located on the case cart 208. For example, the directing component 224 may communicate a notification to the displaying component 226 presenting the following message: “Move this cart to OR 1”. The displaying component 226 may also be configured to allow one or more users of the case cart 208 to interact with the case cart 208 by, for example, utilizing the user interface to acknowledge receipt of the notification. Using the same example, a user may respond to the message displayed on the user interface by selecting an “accept” dialog box indicating to the system that the user will move the cart to OR 1.

The components of the case cart manager system 206 and the case cart system 209 do not perform tasks in isolation; rather, all of the components described herein make up an elaborate feedback system that is best illustrated by the following example. Suppose, for example, that the detecting component 218 of the case cart 208 detects that the case cart 208 has a low battery. The detecting component 218 is configured to generate status information concerning the low battery of case cart 208. The information is communicated to and received at the receiving component 212 of the case cart manager system 206. Meanwhile, the case cart manager system 206 receives information from a scheduler system that the case cart 208 is needed in operating room (OR) 1 at 3 PM. The information from the scheduler system is also received at the receiving component 212 of the case cart manager system 206.

In response to the two items of information received at the receiving component 212 from the case cart 208 and the scheduler system, the determining component 214 determines two actions for the case cart 208 and/or a user of the case cart 208 to perform. The first action might be to recharge the case cart 208. The second action might be to move the case cart 208 to OR 1 at 2:50 PM. Thus, the determining component 214 is configured to determine that the case cart 208 may be needed earlier than the scheduled surgery start time. Furthermore, the determining component 214 can prioritize these actions and determine that the case cart 208 needs to be recharged before being sent to OR 1. The case cart manager system 206 subsequently communicates these two actions, and the priority of the two actions, to the case cart 208.

The case cart system 209 receives information relating to the two actions at the receiving component 222. The directing component 224 thereafter directs a robotics system on the case cart 208 and/or a user to perform the two actions. If the case cart 208 is automated, the directing component 224 directs the robotics system to move the case cart 208 to a recharging station. While moving, the communicating component 220 might communicate with another automated system, such as an automatic door, so that the case cart 208 can navigate throughout the healthcare facility. If the case cart 208 is not automated, the directing component 224 can communicate a notification to the displaying component 226. The displaying component 226 displays the notification, which indicates to the user that the case cart 208 needs recharging. For the second action (i.e., moving to OR 1), the directing component 224 would similarly direct a robotics system on the case cart 208 and/or a user of the case cart 208 to move the case cart 208 to OR 1 at 2:50 PM. If the case cart 208 was in use or inoperable before the scheduled surgery, the determining component 214 could determine that another case cart would need to be sent to OR 1. Upon making this determination, the communicating component 220 would communicate to another case cart or the case cart manager system 206 that another case cart was needed in OR 1.

After the case cart 208 is recharged, the detecting component 218 of the case cart 208 detects a “charged” status for the case cart 208, and the communicating component 220 communicates status information reflecting the “charged” status to the receiving component 212 of the case cart manager system 206. In this way, real-time updates are continuously relayed to the case cart manager system 206. As real-time updates are received at the receiving component 212 of the case cart manager system 206, the determining component 214 of the case cart manager system 206 can determine whether an action for the case cart 208 has been performed. If the receiving component 212 never receives status information reflecting that the case cart 208 is “charged,” for example, the determining component 214 will determine that the case cart 208 still needs recharging and may continue to communicate with the case cart 208 accordingly.

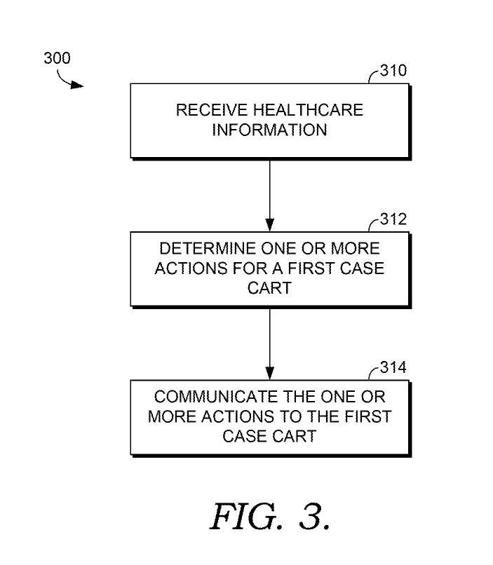

Turning now to FIG. 3, a flow diagram is depicted of an exemplary method 300 for managing one or more case carts, such as the case cart 208 of FIG. 2. At a step 310, information is received by a receiving component, such as the receiving component 212 of FIG. 2. Exemplary information may include, for instance, information pertaining to a healthcare facility or the status of a case cart. The status of a case cart can include, for instance, information regarding remaining battery life, stored inventory, case cart location, whether the case cart is clean or dirty, and the like. Examples of other types of information may include inventory available at a healthcare facility, patient data contained in an EMR, exam or operating room information, scheduling information, real-time location system (RTLS) information, available pharmaceuticals, receivables and purchasing information, case cart washer/sterilizer availability, and the like.

With continued reference to FIG. 3, at a step 312, at least one action for a case cart is determined by a determining component, such as the determining component 214 of FIG. 2, based at least upon receipt of the information. At a step 314, the at least one action is communicated to the case cart by a communicating component, such as the communicating component 216 of FIG. 2. Exemplary actions for a case cart include, for example, moving the case cart from a first location to a second location, refilling the case cart with inventory, unloading inventory from the case cart, staging inventory on or within the case cart, cleaning the case cart, recharging the battery in the case cart, maintaining the current operations of the case cart, sending a notification that the status of the case cart has changed, and the like. Each step of this exemplary method 300 is capable of being performed in real or near-real time.

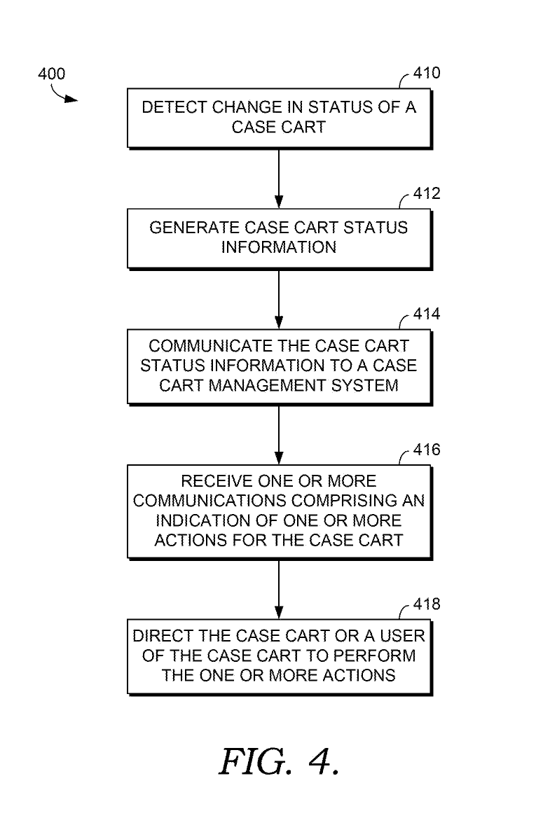

Turning to FIG. 4, a flow diagram is depicted of an exemplary method 400 for directing an automated case cart and/or a user of a case cart to perform one or more actions. At a step 410, a change in the status of an automated case cart is detected by a detecting component, such as the detecting component 218 of FIG. 2. At a step 412, status information is generated by the detecting component based on the status of the case cart. The status information generated at a step 412 is information associated with a change in the status of the case cart. The status information includes, for example, information about whether the case cart is low on battery, filled (i.e., with inventory) or unfilled, clean or dirty, assigned, available, ready, broken or fixed, returned, parked, needing maintenance, washed, en route to a location, or any combination thereof.

With continued reference to FIG. 4, at a step 414, the status information is communicated to a receiving component, such as the receiving component 212 of FIG. 2, by a communicating component, such as the communicating component 220 of FIG. 2. Next, at a step 416, one or more communications is received at a receiving component, such as the receiving component 222 of FIG. 2, at least one communication comprising an indication of one or more actions for the case cart. Finally, at a step 418, the case cart that is automated and/or a user of an automated or non-automated case cart are directed to perform the one or more actions by a directing component, such as the directing component 224 of FIG. 2.

The present invention has been described in relation to particular embodiments, which are intended in all respects to be illustrative rather than restrictive. Alternative embodiments will become apparent to those of ordinary skill in the art to which the present invention pertains without departing from its scope.

1. One or more computer storage media having computer-executable instructions embodied thereon that, when executed, perform a method of managing one or more healthcare facility case carts, the method comprising:
receiving information associated with the one or more healthcare facility case carts;
determining one or more actions for at least a first healthcare facility case cart of the one or more healthcare facility case carts based on the received information; and
communicating the one or more actions to the at least the first healthcare facility case cart.

2. The media of claim 1, wherein the information is received in real or near real-time.

3. The media of claim 1, wherein the information comprises an indication of a battery status of the at least one healthcare facility case cart of the one or more healthcare facility case carts.

4. The media of claim 1, wherein the information comprises an indication of a location of the at least one healthcare facility case cart of the one or more healthcare facility case carts.

5. The media of claim 1, wherein the information comprises an indication of one or more items of inventory associated with the at least one healthcare facility case cart of the one or more healthcare facility case carts.

6. The media of claim 1, wherein the one or more actions includes an indication to move the at least first healthcare facility case cart from a first location to a second location.

7. The media of claim 1, further comprising communicating at least one action of the one or more actions to a healthcare system.

8. The media of claim 1, further comprising determining that at least one action of the one or more actions for the at least the first healthcare facility case cart has been performed.

9. A healthcare facility case cart system, comprising a processor coupled to a computer storage medium, the computer storage medium having stored thereon a plurality of computer software components executable by the processor, the computer software components comprising:
a detecting component that detects a status of the healthcare facility case cart and generates status information;
a communicating component that communicates the status information to a case cart manager system;
a receiving component that receives one or more communications from the case cart manager system, at least one communication of the one or more communications comprising an indication of one or more actions for the healthcare facility case cart; and
a directing component that directs the healthcare facility case cart to perform the one or more actions based on receipt of the at least one communication.

10. The healthcare facility case cart of claim 9, wherein the status information is updated in real or near real-time.

11. The healthcare facility case cart of claim 9, further comprising a communicating component that communicates with one or more healthcare systems to facilitate the one or more actions.

12. The healthcare facility case cart of claim 9, wherein the at least one action comprises the healthcare facility case cart moving from a first location to a second location.

13. The healthcare facility case cart of claim 9, wherein the directing component communicates a notification, the notification comprising an indication of the one or more actions for the healthcare facility case cart.

14. The healthcare facility case cart of claim 13, further comprising a displaying component that presents the notification to a user of the healthcare facility case cart.

15. The healthcare facility case cart of claim 13, wherein the healthcare facility case cart moves automatically.

16. The healthcare facility case cart of claim 14, wherein the notification is presented as a visual or audio display on the case cart.

17. The healthcare facility case cart of claim 14, wherein the notification is presented on a computer that is remote from the case cart.

18. A case cart manager system that manages one or more healthcare facility case carts, the case cart management system comprising a processor coupled to a computer storage medium, the computer storage medium having stored thereon a plurality of computer software components executable by the processor, the computer software components comprising:
a receiving component that receives information, the information being associated with the one or more healthcare facility case carts;
a determining component that determines one or more actions for at least a first healthcare facility case cart of the one or more healthcare facility case carts based on the received information; and
a communicating component that communicates the one or more actions to at least the first healthcare facility case cart of the one or more healthcare facility case carts.

19. The system of claim 18, wherein the receiving component receives the information from the one or more healthcare facility case carts.

20. The system of claim 18, wherein the receiving component receives the information from one or more selected from the following:
(A) an electronic medical record (EMR) system;
(B) a scheduler system;
(C) a pharmacy system;
(D) a real-time location system (RTLS);
(E) an inventory management system;
(F) an implant system;
(G) an explant system;
(H) a purchasing system;
(I) a receivables system; or
(J) a cart washer system.
